(19) United States
(12) Patent Application Publication
(10) Pub. No.: US 2014/0163817 A1
(43) Pub. Date: Jun. 12, 2014

(54) AUTOMOBILE WINDSHIELD WIPER SYSTEM

(71) Applicant: HON HAI PRECISION INDUSTRY CO., LTD., New Taipei (TW)

(72) Inventor: YI-ZHONG SHEU, New Taipei (TW)

(73) Assignee: HON HAI PRECISION INDUSTRY CO., LTD., New Taipei (TW)

(21) Appl. No.: 13/858,035

(22) Filed: Apr. 6, 2013

(30) Foreign Application Priority Data
Dec. 11, 2012 (TW) 101146490

(51) Int. Cl. B60S 1/08

(52) U.S. Cl. CPC B60S 1/0833
USPC 701/36

(57) ABSTRACT

An automobile comprises a front windshield and an auto-sensing windshield wiper system set on the automobile body, an optical signal transmitter device, an optical signal receiving device, and a controller. The optical signal transmitter device and the optical signal receiving device are mounted opposite to each other outside the automobile body, and the controller is mounted inside the automobile body. The optical signal receives an optical signal sent by the optical signal transmitter device and detects a light intensity value of the optical signal. The controller compares the light intensity value with a predetermined light intensity value, and when the light intensity value less than the predetermined light intensity value, the controller turns on the windshield wipers.

### BACKGROUND

1. Technical Field

The present disclosure relates to a automobile, and particularly to an automatic windshield wiper system of the automobile.

2. Description of Related Art

Traditional windshield wiper systems of automobiles are turned on manually; however, this action may cause drivers of the automobiles to be distracted.

Therefore, it is necessary to overcome the above-mentioned problems.

### BRIEF DESCRIPTION OF THE DRAWINGS

Many aspects of the auto-sensing windshield wiper of automobile can be better understood with reference to the following drawings. The components in the drawings are not necessarily drawn to scale, the emphasis instead being placed upon clearly illustrating the principles of the present auto-sensing windshield wiper of automobile. In the drawings, all the views are schematic.

FIG. 1 is a perspective view of the auto-sensing windshield wiper of the automobile of the present disclosure.

FIG. 2 is a view of the operation state of the auto-sensing windshield wiper of the automobile of the FIG. 1.

### DETAILED DESCRIPTION

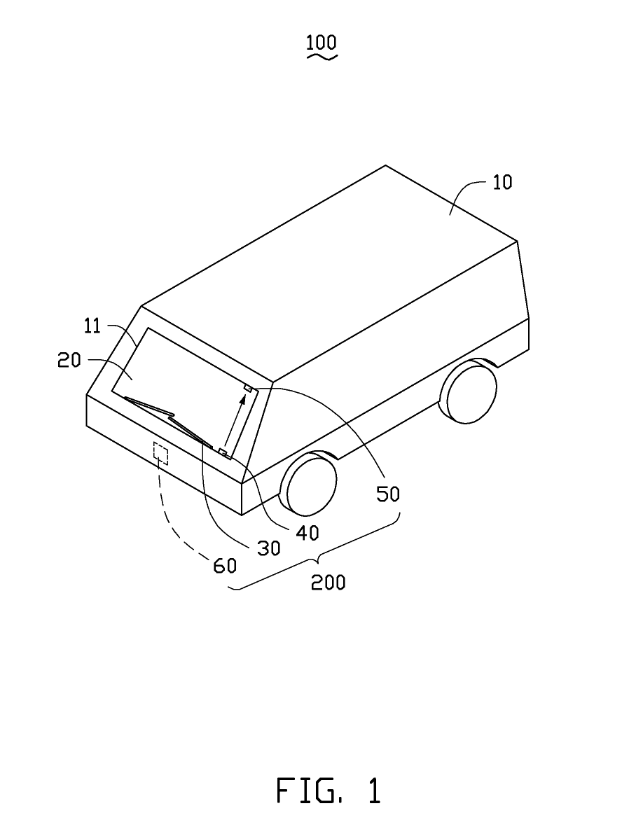

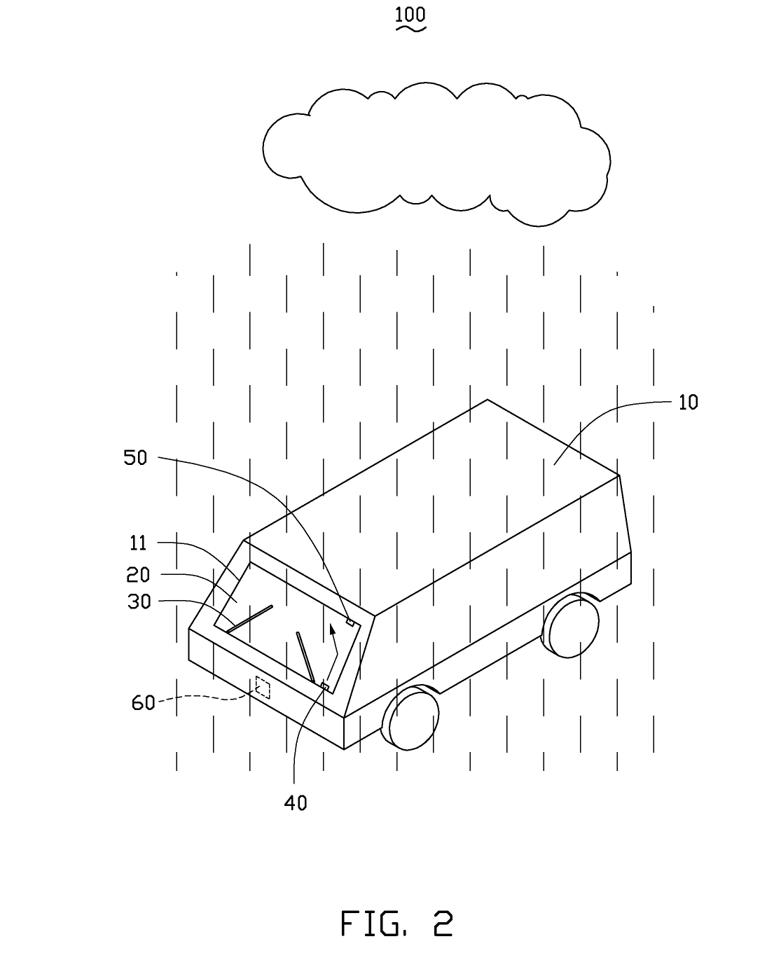

FIG. 1 and FIG. 2 show an automobile 100 according to an exemplary embodiment. The automobile 100 includes an automobile body 10, a front windshield 20 set on the automobile body 10, and an auto-sensing windshield wiper system 200. The auto-sensing windshield wiper system 200, includes a pair of windshield wipers 30 set on the front windshield 20, an optical signal transmitter device 40, an optical signal receiving device 50, and a controller 60. There is a front windshield frame 11 positioned on the automobile body 10, where the shape of the front windshield frame 11 is substantially a trapezoid, however other shapes may be used depending on the embodiment. The front windshield 20 is mounted onto the front windshield frame 11. One end of the pairs of windshield wipers is rotatably fixed to the front windshield frame 11.

The optical signal transmitter device 40 and the optical signal receiving device 50 are mounted opposite to each other outside the automobile body 10. In this embodiment, the optical signal transmitter device 40 and the optical signal receiving device 50 is mounted on the front windshield frame 11. The optical signal transmitter device 40 is positioned closed to the lower edge of the front windshield 20. The optical signal receiving device 50 is positioned closed to the upper edge of the front windshield 20. Both of the optical signal transmitter device 40 and the optical signal receiving device 50 are an infrared laser transmitter device and an infrared laser receiving device.

The controller 60 is mounted inside the automobile body 10, where the controller 60 uses a conducting wire connected with the optical signal transmitter device 40, the optical signal receiving device 50, and the pair of windshield wipers 30. In this embodiment, the controller 60 is an automobile control computer, there is a predetermined light intensity value Iₚ stored in the controller 60. During operation, the optical signal transmitter device 40 sending an optical signal to the optical signal receiving device 50, the sending light intensity of the optical signal transmitter device 40 is Iₘₐₓ, in this embodiment, Iₘₐₓ=1.2×Iₚ. When the optical signal receiving device 50 receives the optical signal, a light intensity value I of the optical signal is received by the detector, then sends the light intensity value I to the controller 60. The controller 60 compares the light intensity value I with the predetermined light intensity value Iₚ, according to the comparison and controls the pair of windshield wipers 30.

When there is no rain, most of the optical signal sent by the optical signal transmitter device 40 can be received by the optical signal receiving device 50, at this moment I≧Iₚ, the controller 60 controls the pair of windshield wipers 30 turn off. When it rains, the optical signal will be refracted and change its direction by the rain, most of the optical signal sent by the optical transmitter device 40 cannot reach to the optical signal receiving device 50, at this moment I<Iₚ, the controller 60 controls the pair of windshield wipers 30 turn on. When it rains the controller 60 can automatically turn on the pair of windshield wipers 30, and will not cause the interference to operation of the automobile when turning on the windshield wiper manually.

Although the present disclosure has been specifically described on the basis of this exemplary embodiment, the disclosure is not to be construed as being limited thereto. Various changes or modifications may be made to the embodiment without departing from the scope and spirit of the disclosure.

What is claimed is:

1. An automobile, comprising an automobile body, a front windshield and an auto-sensing windshield wiper system set on the automobile body, the auto-sensing windshield wiper system comprising a pair of windshield wipers set on the front windshield, the automobile further comprising:
an optical signal transmitter device;
an optical signal receiving device; and
a controller;
wherein the optical signal transmitter device and the optical signal receiving device are mounted opposite to each other outside the automobile body, the controller is mounted inside the automobile body; the optical signal receiving an optical signal sent by the optical signal transmitter device and detecting a light intensity value of the optical signal, and sending the light intensity value to the controller; the controller comparing the light intensity value with a predetermined light intensity value, and when the light intensity value is less than the predetermined light intensity value, the controller turns on the windshield wipers.

2. The automobile as claimed in claim 1, wherein the light intensity value is greater than or equal to the predetermined light intensity value, the controller turns off the windshield wipers.

3. The automobile as claimed in claim 1, wherein the optical signal transmitter device is an infrared light signal transmitter device.

4. The automobile as claimed in claim 1, wherein the optical signal transmitter device is a laser light signal transmitter device.

5. The automobile as claimed in claim 1, wherein the optical signal transmitter device and the optical receiving device are set on a front windshield frame of the automobile.

7. The automobile as claimed in claim 5, wherein the optical signal transmitter device is positioned closed to a lower edge of the front windshield; the optical signal receiving device is positioned closed to an upper edge of the front windshield.
